(19) United States
(12) Patent Application Publication
(10) Pub. No.: US 2014/0214521 A1
(43) Pub. Date: Jul. 31, 2014

(54) Bankcard-System-Based Communication Method Achieving Instantaneous Settlement Between Merchant, Consumer and Distributor

(71) Applicant: Fang Ling, Shenzhen (CN)

(72) Inventor: Fang Ling, Shenzhen (CN)

(21) Appl. No.: 14/342,988

(22) PCT Filed: Dec. 30, 2011
(86) PCT No.: PCT/CN2011/085069

§ 371 Date: Mar. 5, 2014

(30) Foreign Application Priority Data
Dec. 23, 2011 (CN) 201110437860.8

(51) Int. Cl. G06Q 20/34; G06Q 30/02; G06Q 20/20

(52) U.S. Cl. CPC G06Q 20/34; G06Q 20/20; G06Q 30/0238
USPC 705/14.38

(57) ABSTRACT

The present invention utilizes an existing transaction processing and clearance system and POS equipment and implement a management module in the transaction and clearance processing system and a real-time processing module in POS equipment. As such, the present invention allows real time transmission and update of transaction information to the relevant transaction processing and clearance system so as to enhance management and clearance ability thereof. With the use and implementation of the present invention, the participating or clearance bank may effectively monitor the transaction information of the promotional events and allows electronic communication and processing of the transaction information which has not been currently available, and which brings radical changes to and enhance efficiency of current manual transaction clearance practice.

### BACKGROUND OF THE PRESENT INVENTION

1. Field of Invention

The present invention relates to network communication technology, and more particularly to technology relating to instantaneous bankcard settlement system.

2. Description of Related Arts

Currently, the use of bankcards in purchasing are very popular. Conventional bankcard transaction processing system has the following disadvantages. These disadvantages are particularly apparent when the participating banks or merchants are launching promotional events.

When participating banks or merchants are launching promotional events, the participating banks will encourage consumers to use their bankcards to make purchases by providing a variety of promotional deals. These promotional deals are usually limited to discounts, and do not include rebates or merchants incentives, which are even not supported by conventional business transaction systems. Furthermore, when a consumer purchases at a participating merchant through the corresponding bankcards, many participating merchants do not actually provide discounts as agreed between the participating banks and the participating merchants. These situations cause the participating banks to receive many complaints from the relevant consumers. On the other hand, the participating merchants may indeed provide discounts to the relevant consumers, and the participating banks may give some incentives to the participating merchants. The relevant accounting procedures are extremely complex. Conventional accounting procedures are inefficient and ineffective.

Conventional bankcards transaction systems only supports calculation of transaction fees charged by the participating banks but do not usually take into account the promotional events (such as discounts) launched by the participating merchants when calculating the corresponding transaction fees.

Another problem in relation to conventional bankcards transaction systems is that when a particular sale channel refers a sale to a participating merchant, conventional transaction processing system is incapable of verifying if a particular consumer has indeed made a purchase at the relevant participating merchant. This result is that the sale channel may not be able to accurately trace or count how much referral fees may be collected from the participating merchants.

The cause of the above-mentioned problem is that conventional bankcards transaction system does not provide real-time clearance or updated and verified information to participating merchants, participating banks and the corresponding sale channel.

### SUMMARY OF THE PRESENT INVENTION

An objective of the present invention is to provide a method of conducting real-time or instantaneous transactions between a participating merchant, a consumer (user), and a sale channel through the use of a transaction and clearance processing system of a participating bank.

In one aspect of the present invention, it provides a method of conducting real- time or instantaneous transactions processing and settlement between a participating merchant, a consumer (user), and a sale channel, comprising the steps of:

A. establishing, through a management module of an existing transaction and clearance processing system of a participating bank, a digital certificate, transaction starting time, an account holder's name, an account number, a bankcard number of the corresponding participating bank, a verification code of registered POS equipment, discount information and commission information of a particular transaction for a predetermined promotional event, wherein the information is stored in the database of the management module of the transaction and clearance processing system;

B. inputting the digital certificate, the transaction starting time, and discount information into the real-time processing module of the corresponding POS equipment;

C. sending a transaction request from the POS equipment when a bankcard is utilized for purchasing an item through that POS equipment. The management module is then arranged to verify the corresponding POS equipment and the corresponding bankcard. The POS equipment is then arranged to compute the total amount paid by the consumer after the discount, and print out a transaction receipt which indicate the actual amount paid by the consumer after the relevant discount. The POS equipment will then send the transaction information to the management module and stored in the database;

D. For each of the transactions using the corresponding bankcard, the management module calculates processing fee and deduct the processing fee from the total amount paid by the consumer. Moreover, the management module calculate a proper amount of commission and send the commission to the account identified by the account holder's name stated in step A.

The present invention utilizes an existing transaction processing and clearance system and POS equipment and implement a management module in the transaction and clearance processing system and a real-time processing module in POS equipment. As such, the present invention allows real time transmission and update of transaction information to the relevant transaction processing and clearance system so as to enhance management and clearance ability thereof. With the use and implementation of the present invention, the participating or clearance bank may effectively monitor the transaction information of the promotional events and allows electronic communication and processing of the transaction information which has not been currently available, and which brings radical changes to and enhance efficiency of current manual transaction clearance practice.

### DETAILED DESCRIPTION OF THE PREFERRED EMBODIMENT

The present invention allows real-time transaction clearance and settlement between a participating merchant, a consumer, and a sale channel. The present invention provides a method for conducting real-time or instantaneous transactions processing and settlement by utilizing an existing point of sale (POS) equipment and an existing transaction and clearance processing system of a participating bank. Broadly, the present invention provides a management module and a database in an existing transaction and clearance processing system of the bank. Furthermore, the present invention provides a real-time processing module on the POS equipment. The present invention provides a method of conducting real-time or instantaneous transactions processing and settlement between a participating merchant, a consumer (user), and a sale channel, comprising the steps of:

A. establishing, through a management module of an existing transaction and clearance processing system of a participating bank, a digital certificate, transaction starting time, an account holder's name, an account number, a bankcard number of the corresponding participating bank, a verification code of registered POS equipment, discount information and commission information of a particular transaction for a predetermined promotional event, wherein the information is stored in the database of the management module of the transaction and clearance processing system;

B. inputting the digital certificate, the transaction starting time, and discount information into the real-time processing module of the corresponding POS equipment;

C. sending a transaction request from the POS equipment when a bankcard is utilized for purchasing an item through that POS equipment. The management module is then arranged to verify the corresponding POS equipment and the corresponding bankcard. The POS equipment is then arranged to compute the total amount paid by the consumer after the discount, and print out a transaction receipt which indicate the actual amount paid by the consumer after the relevant discount. The POS equipment will then send the transaction information to the management module and stored in the database;

D. For each of the transactions using the corresponding bankcard, the management module calculates processing fee and deduct the processing fee from the total amount paid by the consumer. Moreover, the management module calculate a proper amount of commission and send the commission to the account identified by the account holder's name stated in step A.

The account number and the account holder's name include participating merchants, consumers and sale channel.

Step A comprises a step of setting up the bankcard through the management module, linking the bankcard to the transaction, and setting up the account holder's name, and the account number associated with the bankcard.

The present invention is further elaborated with exemplary operation as follows.

The sale channel links the participating merchants and the participating bank for launching a predetermined promotional event. The promotional event may include applying predetermined discounts or cash back rewards to purchasers (users) who make purchases by using a predetermined bankcard. The promotional event may also include paying predetermined cash rewards by the participating bank to the participating merchants, or paying a predetermined commission by the participating bank to the sale channel. The management module of the transaction and clearance processing system of the participating bank is arranged to set up a digital certificate, transaction starting time, the participating merchants, the verification code of the relevant POS equipment, the discount information and the commission or cash rewards information for the corresponding participating merchant, the commission or cash rewards payable to the sale channel and the corresponding account information, wherein the information is stored in the database linked to the management module. Moreover, step A also comprises the step of inputting the digital certificate, the transaction starting time, discount information into the real-time processing module of the POS equipment. Step A further comprises the step of updating a consumer interface of the management module by adding the information about the promotional event on the consumer interface, wherein the information may include the digital certificate, a brief description of the promotional event, information about the participating merchants, and discounts etc.

The consumer may log in to a customer terminal of the management module, and link his or her bankcard to the promotional event by registering his or her bankcard in the management module, which may then issue a digital certificate which allows application of discounts or other promotional benefits when the consumer uses his or her bankcard to purchase products from the participating merchants. When the promotional event includes cash rewards or rebates from the participating merchants or the participating banks, the consumer may also need to provide or register an account such as a rebate account for receiving the cash rewards or rebates.

When the consumer purchases a product and uses the registered bankcard, the POS equipment will send the corresponding information to the management module. The management module is then arranged to verify the bankcard information and to check the corresponding digital certificate in relation to the promotional events. When the digital certificate is verified, the POS equipment is driven to apply the relevant discounts or benefits to the amount payable by the consumer (the user).

Since the management module and the database store all the information relating to the promotional events, the bankcards, discounts and the benefits, and are linked to the POS equipment, when a particular bankcard is used, the POS equipment may promptly send the bankcard information to the management module and verify the that the bankcard's holder has obtained the necessary digital certificate and qualify for a promotional discounts, benefits, or rewards etc. As a result, every time a transaction is completed, the relevant parties, such as the participating banks, the participating merchants will have the necessary information for transaction clearance and accounting.

Transaction clearance on the part of the participating merchant: when a consumer purchases a product by using the bankcard, the relevant discounts, cash rewards, and the commission will be deducted from the amount paid by the consumer. The remaining balance will be transferred to the account of the corresponding participating merchant.

Transaction clearance on the part of the sale channel: the sale channel is a third party to the transaction. The commission to the sale channel is calculated according to a predetermined agreement. The commission will be transferred to a predetermined account.

Consumer cash rebate or rewards: the corresponding cash rebates or rewards will be transferred to a predetermined account held by the consumer.

Although the transaction processing system of the present invention accomplishes real-time clearance and settlement between a participating merchant, a consumer (user) and a sale channel, it can also be used for multi-party transaction clearance and settlement through the use of the management module as described above.

What is claimed is:

1. A method of conducting real-time transactions processing and clearance by utilizing a POS equipment and a transaction and clearance processing system of a participating bank between a participating merchant, a consumer, and a sale channel, the method is characterized as comprising the steps of:
A. establishing, through a management module of said transaction and clearance processing system of said participating bank, a digital certificate, transaction starting time, an account holder's name, an account number, a bankcard number of said participating bank, a verification code of said registered POS equipment, discount information and commission and rebates information of a particular transaction for a predetermined promotional event, wherein said information is stored in a database of said management module of said transaction and clearance processing system;
B. inputting said digital certificate, said transaction starting time, and discount information into a real-time processing module of said corresponding POS equipment;
C. sending a transaction request from said POS equipment when a bankcard is utilized for purchasing an item through that POS equipment, and verifying, by said management module, said corresponding POS equipment and said corresponding bankcard, wherein said POS equipment is arranged to compute a total amount paid by said consumer after said discount, and print out a transaction receipt which indicate said actual amount paid by said consumer after said relevant discount, wherein said POS equipment is arranged to send said transaction information to said management module and stored in said database; and
D. for each of said transactions using said corresponding bankcard, calculating, by said management module, a processing fee and deducting said processing fee from said total amount paid by said consumer, wherein said management module is arranged to calculates a proper amount of at least one of said commission and rebates and send said corresponding commission and rebates to said account identified by said account holder's name in step A.

2. The method, as recited in claim 1, characterized in that said account number and said account holder's name include those of participating merchants, consumers and sale channel.

3. The method, as recited in claim 2, characterized in that said step A comprises the steps of setting up said bankcard through said management module, linking said bankcard to said transaction.

4. The method, as recited in claim 3, characterized in that said step A further comprises the step of setting up said account holder's name and said account number associated with said bankcard.
